(19) United States
(12) Patent Application Publication
(10) Pub. No.: US 2008/0063332 A1
(43) Pub. Date: Mar. 13, 2008

(54) Hydrodynamic bearing device and motor and recording and reproducing apparatus using the same

(76) Inventors: Takeyoshi Yamamoto, Ehime (JP); Yoichi Nishimoto, Ehime (JP); Akihito Shirai, Ehime (JP)

Correspondence Address: WENDEROTH, LIND & PONACK L.L.P., 2033 K. STREET, NW, SUITE 800, WASHINGTON, DC, 20006, US

(21) Appl. No.: 11/882,939

(22) Filed: Aug. 7, 2007

(30) Foreign Application Priority Data
Aug. 7, 2006 (JP) 2006-214109
Jun. 29, 2007 (JP) 2007-171466

(51) Int. Cl. F16C 33/80; G01D 15/00; H02K 7/10

(52) U.S. Cl. 384/480; 310/75 R; 346/137

(57) ABSTRACT

To provide a hydrodynamic bearing device which can be made small and thin with a sufficient length of the radial bearing being secured, which can prevent leakage of a lubricant even when there is a significant error in shape and/or a disturbance such as a shock and the like, and also which is not affected by deformation of a hub. A radial hydrodynamic bearing is provided between an outer periphery of the shaft and an inner periphery of a sleeve, and a thrust hydrodynamic bearing is formed between a lower surface of the shaft and an upper surface of the thrust plate. Also, a seal portion is formed by an inner peripheral surface of an upper recessed portion of the sleeve, and an outer peripheral surface of a cover plate.

### TECHNICAL FIELD

The present invention relates to a hydrodynamic bearing device using a hydrodynamic bearing, and a motor and a recording and reproducing apparatus using the same.

### BACKGROUND ART

As a bearing device used in spindle motors of hard disc, polygon mirrors, optical disc devices and the like, more hydrodynamic bearing devices, which have higher rotation accuracy than ball bearings and which are also more quiet, are being used instead of conventional ball bearing devices. More hard discs are being used in portable devices, so spindle motors are required to be more small and thin.

As a shape of a bearing which allows miniaturization of spindle motors, Japanese Laid-Open Publication No. 2005-304290 proposes a structure as shown in FIG. 10, in which a radial hydrodynamic bearing is formed between an inner peripheral surface of a sleeve 5, which has radial hydrodynamic grooves 11 formed on its inner peripheral surface, and an outer peripheral surface of a shaft 1. In this structure, thrust hydrodynamic grooves 12 are formed on an upper recessed portion 14 of the sleeve 5. A cover plate 2 is attached to the shaft 1. A thrust hydrodynamic bearing is formed between the upper recessed portion 14 of the sleeve 5 and a lower surface of the cover plate 2. A lubricant, which serves as a lubricant, is filled between the inner peripheral surface of the sleeve 5 and the outer peripheral surface of a shaft 1 and between the upper recessed portion 14 of the sleeve 5 and the lower surface of the cover plate 2, including at least portions which form the radial hydrodynamic bearing and the thrust hydrodynamic bearing. A communication hole 16 is formed for compensating a pressure which connects a lower portion of the radial bearing to an outer periphery of the thrust bearing. With such a structure, a seal portion 15 can be formed between the upper recessed portion 14 of the sleeve 5 and an outer peripheral surface of the cover plate 2, and the seal portion 15 and the radial bearing can be formed so as not to overlap each other in an axial direction. In this way, a sufficient length of the radial bearing can be secured even when the device is made small and thin.

As shown in FIG. 11, Japanese Laid-Open Publication No. 2005-257073 proposes a structure in which a radial hydrodynamic bearing is formed between an inner peripheral surface of a sleeve 5, which has radial hydrodynamic grooves 11 formed on its inner peripheral surface, and an outer peripheral surface of a shaft 1. In this structure, thrust hydrodynamic grooves 12 are formed on an upper surface of the sleeve 5. A cover plate 2 is attached to the shaft 1. A thrust hydrodynamic bearing is formed between the upper surface of the sleeve 5 and a lower surface of the cover plate 2. A lubricant, which serves as a lubricant, is filled between the inner peripheral surface of the sleeve 5 and the outer peripheral surface of a shaft 1 and between the upper surface of the sleeve 5 and the lower surface of the cover plate 2, including at least portions which form the radial hydrodynamic bearing and the thrust hydrodynamic bearing. With such a structure, a seal portion 15 can be formed between the an inner peripheral surface of a stopper 17 which is attached to a sleeve 3 and an outer peripheral surface of the cover plate 2, and the seal portion 15 and the radial bearing can be formed so as not to overlap each other in an axial direction. In this way, a sufficient length of the radial bearing can be secured even when the device is made small and thin.

As shown in FIG. 12, Japanese Laid-Open Publication No. 2005-045924 proposes a structure in which a radial hydrodynamic bearing is formed between an inner peripheral surface of a sleeve 5, which has radial hydrodynamic grooves 11 formed on its inner peripheral surface, and an outer peripheral surface of a shaft 1. In this structure, thrust hydrodynamic grooves 12 are formed on an upper surface of the sleeve 5. A thrust hydrodynamic bearing is formed between the upper surface of the sleeve 5 and a lower surface of a hub 3. Also, thrust sub-hydrodynamic grooves 13 are formed on a lower surface of the sleeve 5. A thrust sub-hydrodynamic bearing is formed between an upper surface of a thrust flange 4, which is attached to the shaft, and the lower surface of the sleeve 5. A lubricant, which serves as a lubricant, is filled between the inner peripheral surface of the sleeve 5 and the outer peripheral surface of a shaft 1, between the upper surface of the sleeve 5 and the lower surface of the hub 3, and between the lower surface of the sleeve 5 and the upper surface of the thrust flange 4, including at least portions which form the radial hydrodynamic bearing and the thrust hydrodynamic bearing. A communication hole 16 is formed for compensating a pressure which connects an outer periphery of the thrust sub-hydrodynamic bearing to an inner periphery of the thrust bearing. With such a structure, a seal portion 15 can be formed between the an inner peripheral surface of a cylindrical wall portion 18 of the hub 3 and an outer peripheral surface of the sleeve 5, and the seal portion 15 and the radial bearing can be formed so as not to overlap each other in an axial direction. In this way, a sufficient length of the radial bearing can be secured even when the device is made small and thin.

### DISCLOSURE OF THE INVENTION

### Problems to be Solved by the Invention

However, the hydrodynamic bearing devices having the conventional structures as disclosed in Japanese Laid-Open Publication Nos. 2005-304290, 2005-257073, and 2005-045924 have a problem that thrust bearings and the seal portions 15 are located nearby so that sealing performance can be readily affected by the bearing portions. When the hydrodynamic pressure generated at the bearing portions has an imbalanced distribution due to a significant error in shape, disturbance such as a shock and the like, the sealing portions 15 are also affected, and the sealing performance deteriorates. As a result, the possibility of oil leakage increases.

An object of the present invention is to solve above-described problems by providing a hydrodynamic bearing device which can be made small and thin with a sufficient length of the radial bearing being secured, and which allows a seal portion which can prevent leakage of a lubricant even when there is a significant error in shape and/or a disturbance such as a shock and the like.

### Means for Solving the Problems

A hydrodynamic bearing device according to the first invention includes a shaft member, a sleeve, a capillary seal portion, a bearing portion, and a buffer portion. The shaft member serves as a center of rotation of a rotary member with respect to a fixed member and has a shaft of a substantially columnar shape and a cover plate of a substantially annular shape. The sleeve relatively rotates with respect to the shaft member and has a recessed portion formed on a surface crossing an axial direction so as to accommodate a part of the cover plate with a gap interposed therebetween on both an inner peripheral side and an outer peripheral side. The capillary seal portion holds a lubricant in a gap between an inner peripheral surface of the recessed portion of the sleeve and an outer peripheral surface of the cover plate. The bearing portion is formed in a gap between the fixed member and the rotary member. The buffer portion is formed in the gap between the cover plate and the recessed portion and secures a distance between the capillary seal portion and the bearing portion.

In this example, the hydrodynamic bearing device has a recessed portion formed on a part of the sleeve along the axial direction, and is formed such that a part of the cover plate of the shaft member is accommodated in the recessed portion with a gap being interposed therebetween on inner and outer peripheral sides. The capillary seal portion configured to hold the lubricant is provided in a gap between the inner peripheral surface of the recessed portion on the sleeve side and the outer peripheral surface of the cover plate. A hydrodynamic groove is not formed on surfaces of the recessed portion of the sleeve and the cover plate partially accommodated therein, which oppose each other. The buffer portion configured to secure the distance between the capillary seal portion and the bearing portion is provided.

In this example, the hydrodynamic bearing device includes both a shaft-rotational type and a shaft-fixed type. The shaft member may be integral to the thrust flange, or may be of a flangeless type. Further, the thrust plate provided on one end surface of the sleeve may be provided on the base side, or on the hub side.

With such a structure, many gaps are formed between the recessed portion formed on the sleeve and the cover plate, which is part of the shaft member relatively rotates with respect to the sleeve. Thus, by providing a radial bearing portion between an outer peripheral surface of the shaft and an inner peripheral surface of the sleeve and a thrust bearing portion between the shaft member, and the thrust plate, for example, distances from both bearing portions to the capillary seal portion can be expanded compared to the conventional art. As a result, since the capillary seal portion and the radial bearing portion do not overlap in the axial direction, a sufficient length of the radial bearing can be secured. Further, since the bearings are remote from the capillary seal portion, the influence of the bearing portions on the capillary seal portion can be reduced, and the sealing function can be improved. As a result, it becomes possible to realize a hydrodynamic bearing device which can be made small and thin with a sufficient length of the radial bearing being secured, and which can prevent leakage of a lubricant even when there is a significant error in shape and/or a disturbance such as a shock and the like.

A hydrodynamic bearing device according to the second embodiment is a hydrodynamic bearing device including a stationary member and a rotary member, which has a lubricant in a gap with the stationary member and can relatively rotate with respect to the stationary member, in which the rotary member includes a shaft member and a hub attached to the shaft member. The shaft member includes a shaft and a cover plate. The stationary member includes a base and a sleeve attached to the base. The sleeve has an inner peripheral surface which opposes an outer peripheral surface of the shaft in a radial direction. The sleeve has a thrust plate configured to cover one end of the inner peripheral surface attached thereto. A surface of the thrust plate on one end in an axial direction is located so as to oppose a surface of the shaft on the other end in the axial direction. A recessed portion configured to accommodate a part of the cover plate is formed on a surface of the sleeve on the one end in the axial direction. A seal portion configured to hold the lubricant is formed between an inner peripheral surface of the recessed portion of the sleeve and an outer peripheral surface of the cover plate. A hydrodynamic groove is not formed on the recessed portion of the sleeve and a surface of the cover plate, which opposes the recessed portion.

In this example, the hydrodynamic bearing device has a recessed portion formed on a part of the sleeve along the axial direction, and is of a so-called shaft-rotational flangeless type formed such that a part of the cover plate of the shaft member is accommodated in the recessed portion with a gap being interposed therebetween on inner and outer peripheral sides. The seal portion configured to hold the lubricant is provided in a gap between the inner peripheral surface of the recessed portion on the sleeve side and the outer peripheral surface of the cover plate. A hydrodynamic groove is not formed on surfaces of the recessed portion of the sleeve and the cover plate which opposes thereto. The inner peripheral surface and the outer peripheral surface as mentioned above mean an inner surface and an outer peripheral surface in a radial direction of a circle with the rotational axis of the shaft member being the center, respectively.

With such a structure, a hydrodynamic groove is not formed on opposing surfaces which form the gap between the recessed portion formed on the sleeve and the cover plate, which is part of the shaft member relatively rotates with respect to the sleeve. Thus, a sufficient distance between the seal portion and the bearing portions in which they hydrodynamic grooves are formed can be secured. As a result, since the seal portion and the radial bearing portion do not overlap in the axial direction, a sufficient length of the radial bearing can be secured. Further, since the bearings are remote from the seal portion, the influence of the bearing portions on the seal portion can be reduced, and the sealing function can be improved. Moreover, by providing a thrust bearing portion on one of the opposing surfaces of the shaft and the thrust plate, for example, even when the hub of the rotary member deforms, the performance of the thrust bearing portion can be prevented from deteriorating. As a result, it becomes possible to realize a hydrodynamic bearing device which can be made small and thin with a sufficient length of the radial bearing being secured, and which can prevent leakage of a lubricant even when there is a significant error in shape and/or a disturbance such as a shock and the like.

A hydrodynamic bearing device according to the third embodiment is a hydrodynamic bearing device including a stationary member and a rotary member, which has a lubricant in a gap with the stationary member and can relatively rotate with respect to the stationary member, in which the rotary member includes a shaft member and a hub attached to the shaft member. The shaft member includes a shaft, a cover plate, and a thrust flange. The stationary member includes a base and a sleeve attached to the base. The sleeve has an inner peripheral surface which opposes an outer peripheral surface of the shaft in a radial direction. The sleeve has a thrust plate configured to cover one end of the inner peripheral surface attached thereto. A surface of the thrust flange on one end in an axial direction and a surface on the other end are located so as to oppose a surface of the sleeve on the other end in the axial direction and a surface of the thrust plate on the one end in the axial direction, respectively. A recessed portion configured to accommodate a part of the cover plate is formed on a surface of the sleeve on the one end in the axial direction. A seal portion configured to hold the lubricant is formed between an inner peripheral surface of the recessed portion of the sleeve and an outer peripheral surface of the cover plate. A hydrodynamic groove is not formed on the recessed portion of the sleeve and a surface of the cover plate on the other end in the axial direction, which opposes the recessed portion.

In this example, the hydrodynamic bearing device has a recessed portion formed on a part of the sleeve along the axial direction, and is of a so-called shaft-rotational flanged type formed such that a part of the cover plate of the shaft member is accommodated in the recessed portion with a gap being interposed therebetween on inner and outer peripheral sides. The seal portion configured to hold the lubricant is provided in a gap between the inner peripheral surface of the recessed portion on the sleeve side and the outer peripheral surface of the cover plate. A hydrodynamic groove is not formed on surfaces of the recessed portion of the sleeve and the cover plate which opposes thereto. The inner peripheral surface and the outer peripheral surface as mentioned above mean an inner surface and an outer peripheral surface in a radial direction of a circle with the rotational axis of the shaft member being the center, respectively.

With such a structure, a hydrodynamic groove is not formed on opposing surfaces which form the gap between the recessed portion formed on the sleeve and the cover plate, which is part of the shaft member relatively rotates with respect to the sleeve. Thus, a sufficient distance between the seal portion and the bearing portions in which they hydrodynamic grooves are formed can be secured. As a result, since the seal portion and the radial bearing portion do not overlap in the axial direction, a sufficient length of the radial bearing can be secured. Further, since the bearings are remote from the seal portion, the influence of the bearing portions on the seal portion can be reduced, and the sealing function can be improved. Moreover, by providing a thrust bearing portion on one of the opposing surfaces of the thrust flange and the thrust plate, and/or one of the opposing surfaces of the thrust flange and the sleeve, for example, even when the hub of the rotary member deforms, the performance of the thrust bearing portion can be prevented from deteriorating. As a result, it becomes possible to realize a hydrodynamic bearing device which can be made small and thin with a sufficient length of the radial bearing being secured, and which can prevent leakage of a lubricant even when there is a significant error in shape and/or a disturbance such as a shock and the like.

A hydrodynamic bearing device according to the fourth embodiment is a hydrodynamic bearing device including a stationary member and a rotary member, which has a lubricant in a gap with the stationary member and can relatively rotate with respect to the stationary member, in which the stationary member includes a base and a shaft member attached to the base. The shaft member includes a shaft and a cover plate. The rotary member includes a sleeve and a hub attached to the sleeve. The sleeve has an inner peripheral surface which opposes an outer peripheral surface of the shaft in a radial direction. The sleeve has a thrust plate configured to cover one end of the inner peripheral surface attached thereto. A surface of the thrust plate on the other end in an axial direction opposes a surface of the shaft on one end in the axial direction. A recessed portion configured to accommodate a part of the cover plate is formed on a surface of the sleeve on the other end in the axial direction, and a seal portion configured to hold the lubricant is formed between an inner peripheral surface of the recessed portion of the sleeve and an outer peripheral surface of the cover plate. A hydrodynamic groove is not formed on the recessed portion of the sleeve and a surface of the cover plate, which opposes the recessed portion.

In this example, the hydrodynamic bearing device has a recessed portion formed on a part of the sleeve along the axial direction, and is of a so-called shaft-fixed flangeless type formed such that a part of the cover plate of the shaft member is accommodated in the recessed portion with a gap being interposed therebetween on inner and outer peripheral sides. The seal portion configured to hold the lubricant is provided in a gap between the inner peripheral surface of the recessed portion on the sleeve side and the outer peripheral surface of the cover plate. A hydrodynamic groove is not formed on surfaces of the recessed portion of the sleeve and the cover plate which opposes thereto. The inner peripheral surface and the outer peripheral surface as mentioned above mean an inner surface and an outer peripheral surface in a radial direction of a circle with the rotational axis of the shaft member being the center, respectively.

With such a structure, a hydrodynamic groove is not formed on opposing surfaces which form the gap between the recessed portion formed on the sleeve and the cover plate, which is part of the shaft member relatively rotates with respect to the sleeve. Thus, a sufficient distance between the seal portion and the bearing portions in which they hydrodynamic grooves are formed can be secured. As a result, since the seal portion and the radial bearing portion do not overlap in the axial direction, a sufficient length of the radial bearing can be secured. Further, since the bearings are remote from the seal portion, the influence of the bearing portions on the seal portion can be reduced, and the sealing function can be improved. Moreover, by providing a thrust bearing portion on one of the opposing surfaces of the shaft and the thrust plate, for example, even when the hub of the rotary member deforms, the performance of the thrust bearing portion can be prevented from deteriorating. As a result, it becomes possible to realize a hydrodynamic bearing device which can be made small and thin with a sufficient length of the radial bearing being secured, and which can prevent leakage of a lubricant even when there is a significant error in shape and/or a disturbance such as a shock and the like.

A hydrodynamic bearing device according to the fifth embodiment is a hydrodynamic bearing device including a stationary member and a rotary member, which has a lubricant in a gap with the stationary member and can relatively rotate with respect to the stationary member, in which the stationary member includes a base and a shaft member attached to the base. The shaft member includes a shaft and a cover plate. The rotary member includes a sleeve and a hub attached to the sleeve. The sleeve has an inner peripheral surface which opposes an outer peripheral surface of the shaft in a radial direction. The sleeve has a thrust plate configured to cover one end of the inner peripheral surface attached thereto. A surface of the thrust plate on the other end in an axial direction opposes a surface of the thrust flange on one end in the axial direction. A surface of the sleeve on the one end in the axial direction opposes a surface of the thrust flange on the other end in the axial direction. A recessed portion configured to accommodate a part of the cover plate is formed on a surface of the sleeve on the other end in the axial direction. A seal portion configured to hold the lubricant is formed between an inner peripheral surface of the recessed portion of the sleeve and an outer peripheral surface of the cover plate. A hydrodynamic groove is not formed on the recessed portion of the sleeve and a surface of the cover plate, which opposes the recessed portion.

In this example, the hydrodynamic bearing device has a recessed portion formed on a part of the sleeve along the axial direction, and is of a so-called shaft-fixed flanged type formed such that a part of the cover plate of the shaft member is accommodated in the recessed portion with a gap being interposed therebetween on inner and outer peripheral sides. The seal portion configured to hold the lubricant is provided in a gap between the inner peripheral surface of the recessed portion on the sleeve side and the outer peripheral surface of the cover plate. A hydrodynamic groove is not formed on surfaces of the recessed portion of the sleeve and the cover plate which opposes thereto. The inner peripheral surface and the outer peripheral surface as mentioned above mean an inner surface and an outer peripheral surface in a radial direction of a circle with the rotational axis of the shaft member being the center, respectively.

With such a structure, a hydrodynamic groove is not formed on opposing surfaces which form the gap between the recessed portion formed on the sleeve and the cover plate, which is part of the shaft member relatively rotates with respect to the sleeve. Thus, a sufficient distance between the seal portion and the bearing portions in which they hydrodynamic grooves are formed can be secured. As a result, since the seal portion and the radial bearing portion do not overlap in the axial direction, a sufficient length of the radial bearing can be secured. Further, since the bearings are remote from the seal portion, the influence of the bearing portions on the seal portion can be reduced, and the sealing function can be improved. Moreover, by providing a thrust bearing portion on one of the opposing surfaces of the shaft and the thrust plate, and/or one of the opposing surfaces of the thrust flange and the sleeve, for example, even when the hub of the rotary member deforms, the performance of the thrust bearing portion can be prevented from deteriorating. As a result, it becomes possible to realize a hydrodynamic bearing device which can be made small and thin with a sufficient length of the radial bearing being secured, and which can prevent leakage of a lubricant even when there is a significant error in shape and/or a disturbance such as a shock and the like.

### Effects of the Invention

According to the above-described inventions, the seal portion and the radial bearing do not overlap in the axial direction. Thus, the radial bearing can be long. Further, since the bearing portion and the seal portion are remote from each other, the influence of the bearing portion on the seal portion can be reduced, and the sealing performance can be increased. As a result, it becomes possible to make the hydrodynamic bearing device small and thin with a sufficient length of the radial bearing being secured, and to prevent leakage of a lubricant even when there is a significant error in shape and/or a disturbance such as a shock and the like.

### BRIEF DESCRIPTION OF THE DRAWINGS

FIG. 1 is a cross-sectional view of a hydrodynamic bearing device according to the first embodiment of the present invention.

FIGS. 2A through 2D are cross-sectional views of a fastened portion between a shaft, a cover plate, and a hub according to the present invention.

FIGS. 3A through 3D are enlarged cross-sectional views of radial hydrodynamic grooves according to the present invention.

FIGS. 4A through 4D are enlarged cross-sectional views of structures of a seal portion according to the present invention.

FIG. 5 is a cross-sectional view of a hydrodynamic bearing device according to the second embodiment of the present invention.

FIG. 6 is a cross-sectional view of a hydrodynamic bearing device according to the third embodiment of the present invention.

FIG. 7 is a cross-sectional view of a hydrodynamic bearing device according to the fourth embodiment of the present invention.

FIG. 8 is a cross-sectional view of a hydrodynamic bearing device according to the fifth embodiment of the present invention.

FIG. 9 is a cross-sectional view of a hydrodynamic bearing device according to the sixth embodiment of the present invention.

FIG. 10 is a cross-sectional view of a conventional spindle motor.

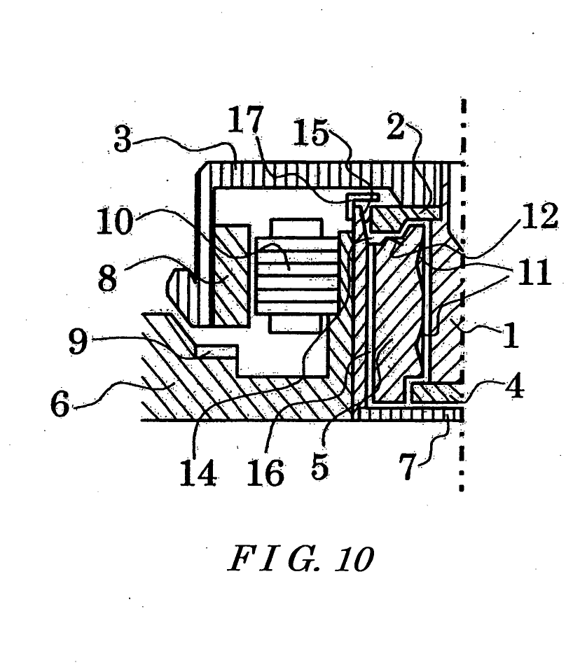

FIG. 11 is a cross-sectional view of another conventional spindle motor.

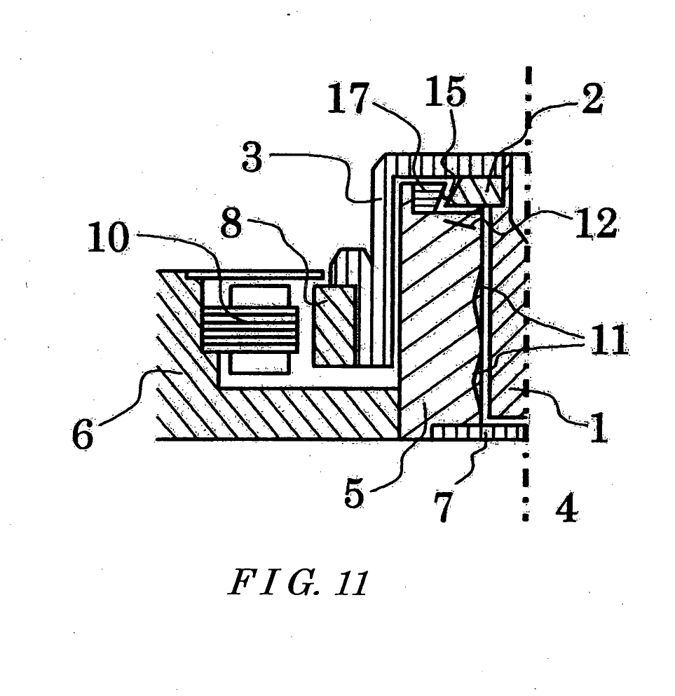

FIG. 12 is a cross-sectional view of yet another conventional spindle motor.

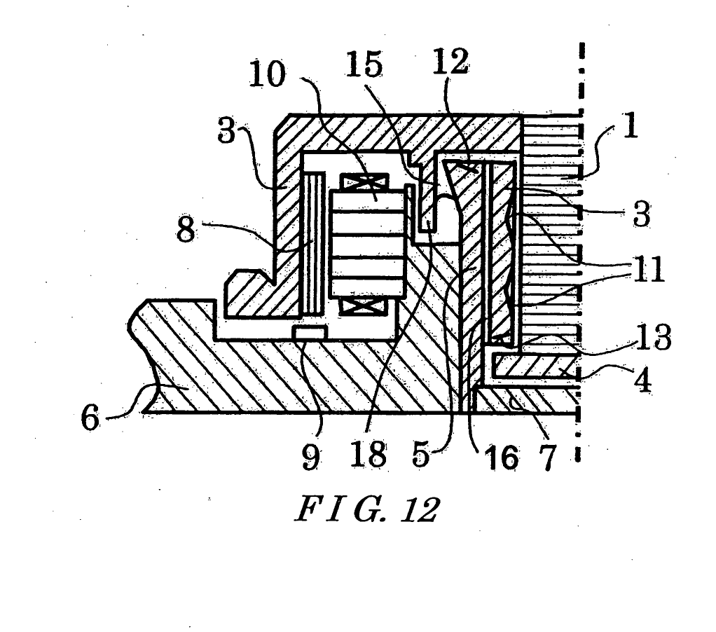

FIG. 13 is a cross-sectional view of a hydrodynamic bearing device according to the seventh embodiment of the present invention.

FIG. 14 is a partially enlarged view of FIG. 13.

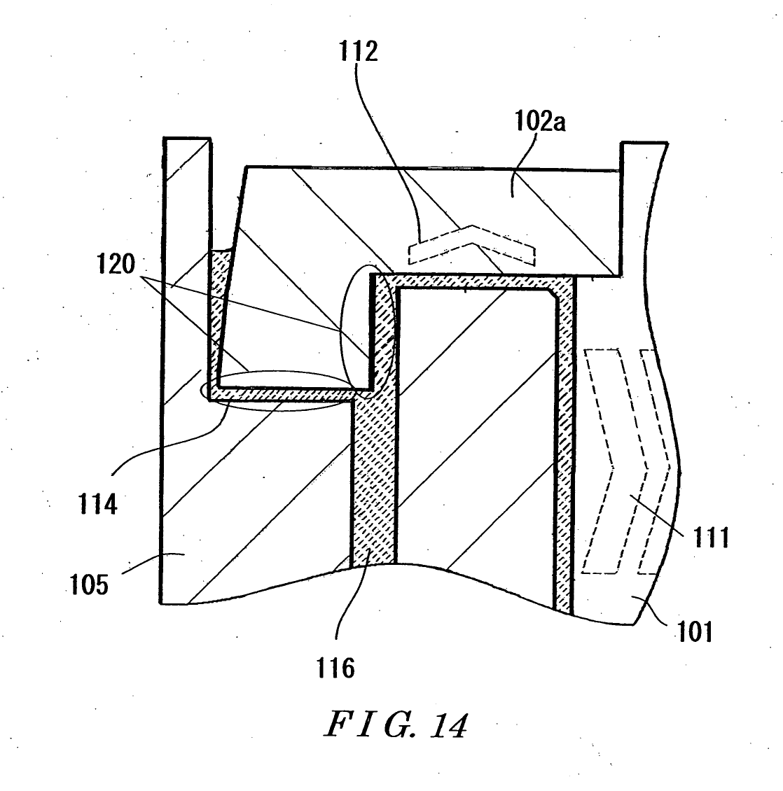

### BEST MODE FOR CARRYING OUT THE INVENTION

Hereinafter, spindle motors and rotary devices according to an embodiment of the present invention will be described with reference to the drawings.

### First Embodiment

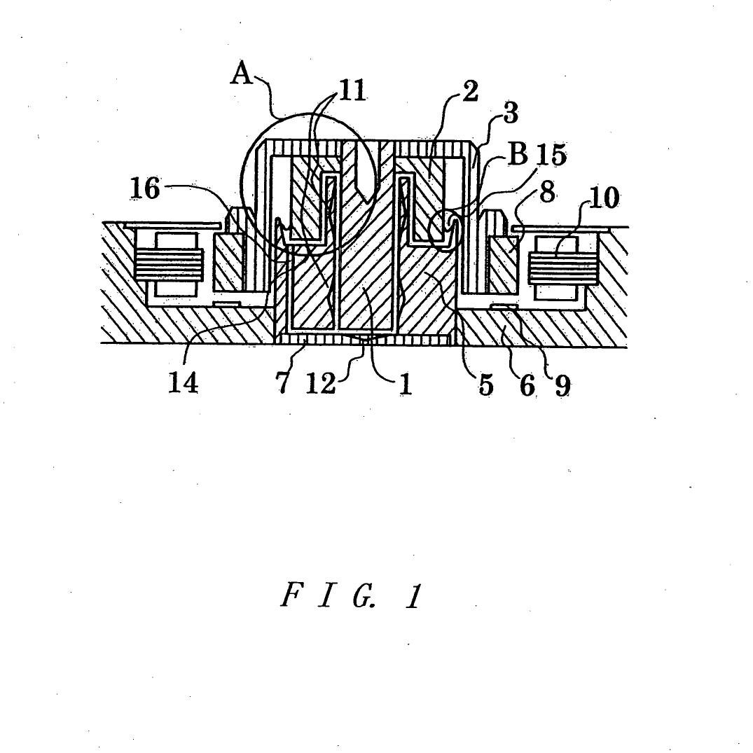

FIG. 1 is a cross-sectional diagram showing a spindle motor including a hydrodynamic bearing device according to the first embodiment of the present invention. The hydrodynamic bearing device forms a rotor which has a shaft 1 of a substantially columnar shape, and a cover plate 2 of a substantially annular shape and a hub 3 attached thereto, and which rotates with the shaft 1 being a central axis. The shaft. 1 and the cover plate may be integral to each other.

To a base 6, a sleeve 5 is attached and forms a stator (a stationary member (fixed member)). The sleeve 5 is located outside the shaft 1 with a small space interposed therebetween. The rotor including the shaft 1 is supported so as to be rotatable with respect to the sleeve 5. One end of the sleeve 5 is covered with a thrust plate 7 so as to surround a thrust flange 4.

On an outer peripheral surface of the hub 3, a circular magnet 8 which is multipolarly magnetized in a circumferential direction, is attached. A stator core 10 is attached to the base 6 at a position opposing the magnet 8. When a controlled electric current is supplied to a coil wound around the stator core 10, a rotational force is generated between the stator core 10 and the magnet 8, and the stator core 10 serves as a driving mechanism for rotating the rotor with respect to the stator.

On at least one of an outer peripheral surface of the shaft 1 and an inner peripheral surface of the sleeve 5, radial hydrodynamic grooves 11 are formed. Between the outer peripheral surface of the shaft 1 and the inner peripheral surface of the sleeve 5, a lubricating oil, which serves as a lubricant (a working fluid), is filled. Thus, when the shaft 1 rotates, a hydrodynamic pressure is generated between the outer peripheral surface of the shaft 1 and the inner peripheral surface of the sleeve 5, and a radial hydrodynamic bearing is formed. The radial hydrodynamic bearing supports the shaft 1 in a radial direction with respect to the sleeve 5 in a non-contact state.

On at least one of a lower surface (a surface on the other end in the axial direction) of the shaft 1 and an upper surface (a surface on one end in the axial direction) of the thrust plate 7, thrust hydrodynamic grooves 12 are formed. Between the lower surface of the shaft 1 and the upper surface of the thrust plate 7, a lubricating oil, which serves as a lubricant, is filled. Thus, when the shaft 1 rotates, a hydrodynamic pressure is generated between the lower surface of the shaft 1 and the upper surface of the thrust plate 7 and a thrust hydrodynamic bearing is formed. The thrust hydrodynamic bearing supports the cover plate 2 in an axial direction with respect to the sleeve 5 in a non-contact state.

To a base 6, an attraction ring 9 which is formed of a magnetic body is attached. A magnetic attraction force in the axial direction is generated between the attraction ring 9 and the magnet 8 such that a balance between the magnetic attraction force and the hydrodynamic pressure generated by the thrust hydrodynamic bearing is kept to support the rotor stably in the axial direction. Such magnetizing may also be generated by shifting magnetic centers of the stator core 10 and the magnet 8 in the axial direction.

On an upper surface of the sleeve 5, an upper recessed portion 14 is formed. A part of the cover plate 2 having a cap shape is accommodated within the upper recessed portion 14. On an inner peripheral surface of the upper recessed portion 14, a tapered portion, which extends outward with the shaft 1 being the center, is formed. The inner peripheral surface of the upper recessed portion 14 and an outer peripheral surface of the cover plate 2 form a seal portion 15 for preventing leakage of the lubricating oil in cooperation with each other. The seal portion utilizes a capillary force.

In the present embodiment, since the radial bearing, the thrust bearing, and the seal portion 15 are formed as described above, the seal portion 15 and the radial bearing do not overlap each other in the axial direction. Thus, it becomes possible to secure a sufficient length of the radial bearing. Furthermore, since the seal portion 15 is remote from the radial bearing and the thrust bearing, influence of the bearing on the seal portion 15 can be reduced. Therefore, even when the hydrodynamic pressures generated at the bearing portions have an imbalanced distribution, the sealing performance does not deteriorate. Moreover, since the thrust bearing is formed between the thrust flange 4 and the thrust plate 7, the performance of the thrust bearing can be prevented from deteriorating even if the hub 3 deforms when a disc or the like is attached to the hub 3.

Between a thrust bearing outer peripheral portion of the sleeve 5 and the upper recessed portion 14, a communication hole 16 is formed. By forming such a communication hole 16, even when a pressure difference is generated between upper and lower ends in the axial direction in the lubricating oil held between the inner peripheral surface of the sleeve 5 and the outer peripheral surface of the shaft 1 due to errors in machining hydrodynamic grooves provided at the bearing portions and/or other parts, the pressure difference can be compensated through the communication hole 16. Thus, generation of bubbles due to a negative pressure in the lubricating oil, and/or too much floating of the rotor can be suppressed. Even in case of a bubble being generated, the bubble can be discharged outside the bearings through the communication hole 16. The communication hole 16 can be formed by cutting, laser, electrolytic machining or the like.

In this example, the sleeve 5 is formed of one component. However, it can be formed of two or more components. When two or more components are used, the communication hole 16 can be easily formed by forming grooves on joint surfaces of the components.

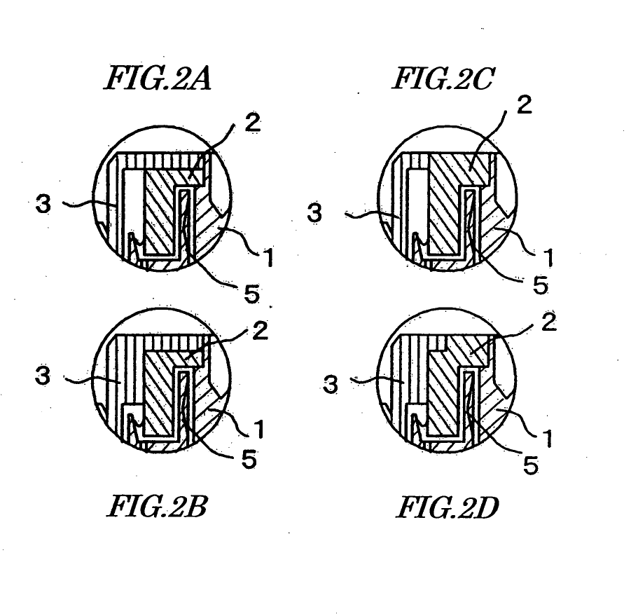

FIGS. 2A through 2D show other structures of the coupled portion between the shaft 1, and the cover plate 2 and the hub 3 (portion A). FIG. 2A shows a structure in which the shaft has a stepped shape and the cover plate 2 is held between the stepped portion of the shaft 1 and the hub 3. With such a structure, precision of alignment in the axial direction can be improved. FIG. 2B shows a structure in which an outer peripheral portion of the cover plate is covered with the hub 3. With such a structure, an area of the coupled portion becomes large and a coupling force can be enhanced. FIG. 2C shows a structure in which the hub 3 is attached to the shaft 1 via the cover plate 2. With such a structure, an area of the coupled portion between the shaft 1 and the cover plate 2 becomes large and a coupling force can be enhanced. FIG. 2D shows a stepped shape such that the outer periphery of the cover plate 2 and the inner periphery of the hub 3 fit each other. With such a structure, precision of alignment of the hub 3 in the axial direction can be improved. Alternatively, the cover plate 2 and the hub 3 may be integrally formed.

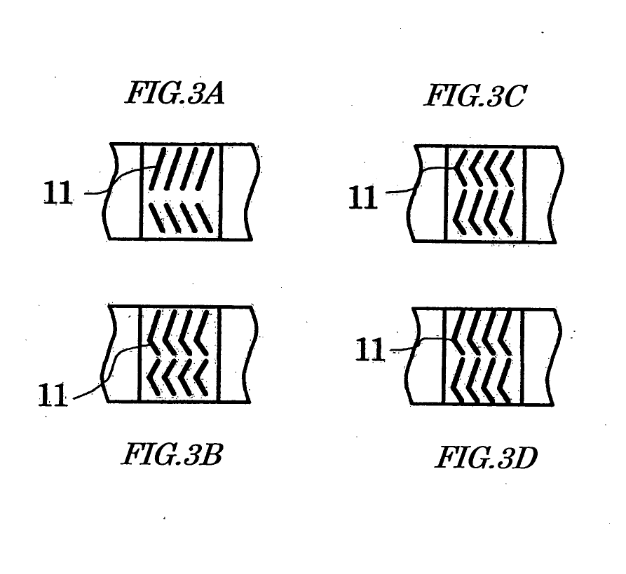

FIGS. 3A through 3D show examples of patterns of the radial hydrodynamic grooves 11. The radial hydrodynamic grooves 11 have a pumping-in shape which induces a pressure toward the lower side in the axial direction to the lubricating oil when the rotor is rotating. The grooves may have an imbalanced open v-shaped pattern with the grooves on the upper side in the axial direction being longer (FIG. 3A), or may have herringbone patterns (FIGS. 3B through 3D). FIG. 3B shows a pattern with the upper side grooves having imbalanced shapes; FIG. 3C shows a pattern with the lower side grooves having imbalanced shapes; and FIG. 3D shows a pattern with both side grooves having imbalanced shapes. With such a structure, a flow of the lubricating oil which circulates from the radial bearings to the communication hole 16 is generated. Thus, even when a bubble is generated at the bearings, it can be rapidly discharged outside the bearings through the communication hole. FIGS. 3B through 3D show two sets of herringbone grooves. However, there may be one set, or three or more sets.

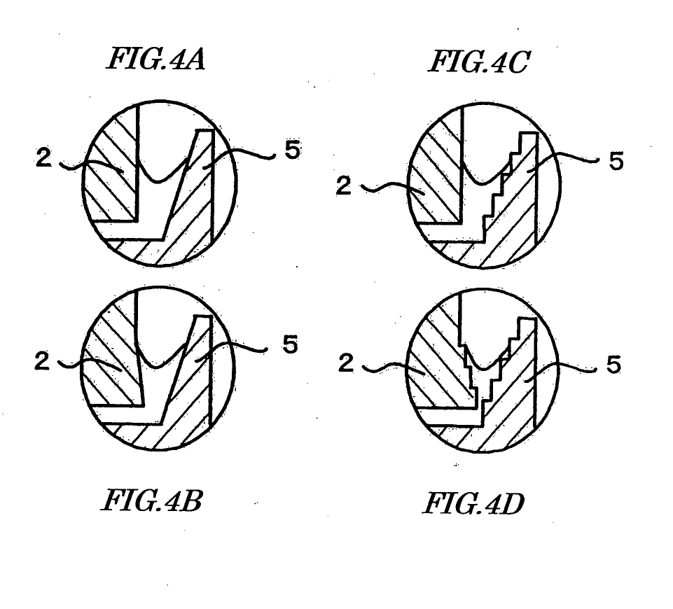

FIGS. 4A through 4D show examples of a shape of the seal portion 15. In FIG. 4A, only the inner peripheral portion of the upper recessed portion 14 is tapered. In FIG. 4B, both the inner peripheral portion of the upper recessed portion and the outer peripheral portion of the cover plate 2 are tapered. In FIG. 4C, tiered steps are formed on only the inner peripheral portion of the upper recessed portion 14. In FIG. 4D, tiered steps are formed on both the inner peripheral portion of the upper recessed portion and the outer peripheral portion of the cover plate 2. The seal portion has a shape such that a gap becomes wider toward the opening, and utilizes a capillary force. The tapered shape and the tiered steps may be combined.

In FIG. 1, a stopper structure for the rotor portion (rotary member), which is formed of the shaft 1, the cover plate 2, the sleeve 5, the hub 3, and the magnet 8, is not shown. However, a stopper structure may be formed by providing an locking structure between the rotary member such as a rotor portion and a stationary portion (fixed member), which is formed of the base 6, the sleeve 5, and the thrust plate 7.

In the present embodiment, the lubricating oil is used as the lubricant. However, high-flow grease or ionic liquids may be used.

### Second Embodiment

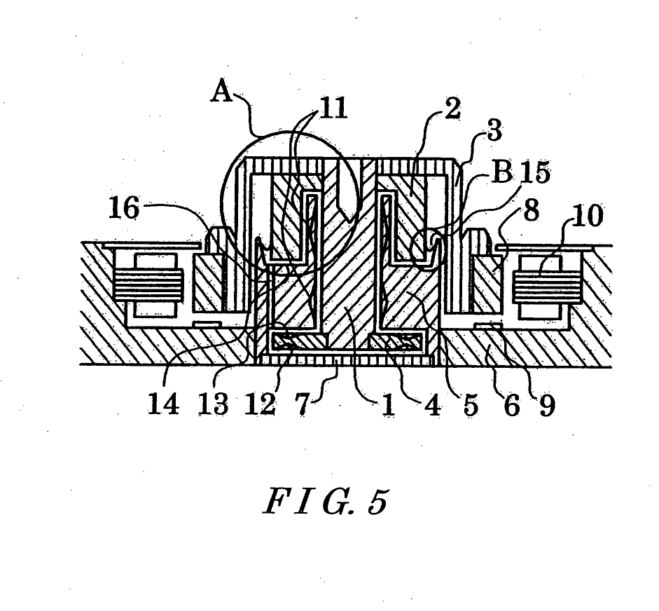

FIG. 5 is a cross-sectional view of a spindle motor including a hydrodynamic bearing device according to the second embodiment of the present invention. In the above hydrodynamic bearing device of the first embodiment, the thrust bearing is formed between the lower surface of the shaft 1 and the upper surface of the thrust plate 7. In contrast, in the hydrodynamic bearing device of the present embodiment, a thrust flange 4 is attached to the shaft 1, and thrust bearings (the thrust hydrodynamic grooves 12 and thrust sub-hydrodynamic grooves 13) are provided between a lower surface of the thrust flange 4 and the upper surface of the thrust plate 7, and between the thrust flange 4 and the sleeve 5, respectively. Except for this point, other parts of the structure are similar to those of the above embodiment.

With such a structure, the seal portion 15 and the thrust bearing portion can be remote from each other, and the radial bearing portion and the seal portion 15 do not overlap each other in the axial direction. Thus, a sufficient length of the radial bearing can be secured. Since the seal portion 15 is sufficiently remote from the radial bearing and the thrust bearing, the influence of the bearing portions on the seal portion 15 can be reduced. Therefore, even when the hydrodynamic pressures generated at the bearing portions have an imbalanced distribution, the sealing performance does not deteriorate. Furthermore, since the thrust bearings are provided between the thrust flange 4 and the thrust plate 7, and between the thrust flange 4 and the sleeve 5, even if the hub 3 deforms when a disc or the like is attached to the hub 3, the thrust bearing performance can be prevented from deteriorating. Such effects similar to those described above can be achieved.

Moreover, since an area of the thrust bearing can be increased with such a structure, rigidity of the thrust bearing can be improved.

Further, the thrust sub-hydrodynamic grooves 13 are formed on at least one of the upper surface of the thrust flange 4 and the lower surface of the sleeve 5. The lubricating oil is filled between the upper surface of the thrust flange 4 and the lower surface of the sleeve 5 as a lubricant. Thus, when the thrust flange 4 rotates, a hydrodynamic pressure is generated between the upper surface of the thrust flange 4 and the lower surface of the sleeve 5, and the thrust sub-hydrodynamic bearing is formed. With such a thrust sub-hydrodynamic bearing, a load in the direction opposite to that for the thrust hydrodynamic bearing can be supported, and the performance of the thrust bearing is improved.

According to the structure of the present embodiment, effects achieved by the structure described in the first embodiment can also be achieved.

### Third Embodiment

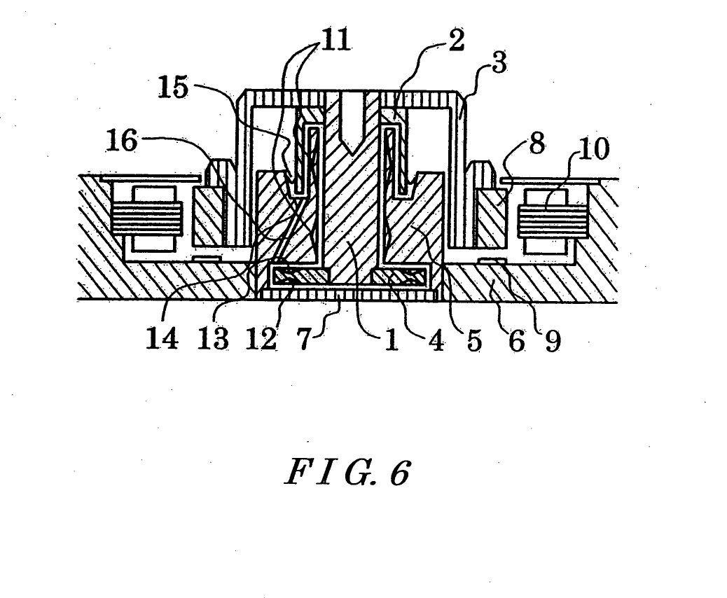

FIG. 6 is a cross-sectional view of a spindle motor including a hydrodynamic bearing device according to the second embodiment of the present invention. In the above hydrodynamic bearing device of the third embodiment, the communication hole 16 is formed vertically from the outer peripheral side of the thrust bearing. In contrast, in the hydrodynamic bearing device of the present embodiment, the communication hole 16 is formed diagonally toward the inner periphery. Except for this point, other parts of the structure are similar to those of the above embodiment.

In the present embodiment the thrust hydrodynamic grooves 12 and the thrust sub-hydrodynamic grooves 13 are provided on the thrust flange 4. Thus, the opening on one end of the communication hole 16 is located outside the hydrodynamic grooves. If the communication hole 16 is parallel to the axial direction, the position of the opening on the other end of the communication hole 16 shifts toward a direction such that the distance in the radial direction becomes longer. Since the pressure at the outer peripheral portion of the thrust flange 4 tends to become a negative pressure, the diameter the seal portion 15 has to be large when the opening on the other end of the communication hole 16 is connected to the bottom surface of the upper recessed portion 14.

In the present embodiment, since the above-described structure is employed, the diameter of the seal portion 15 can be reduced. Accordingly, the peripheral speed at the seal portion 15 becomes slower and rippling of the lubricating oil due to surface roughness of the seal portion 15 or the like is reduced. Thus, the sealing performance can be further improved.

According to the structure of the present embodiment, effects achieved by the structure described in the first embodiment and the like can also be achieved.

### Fourth Embodiment

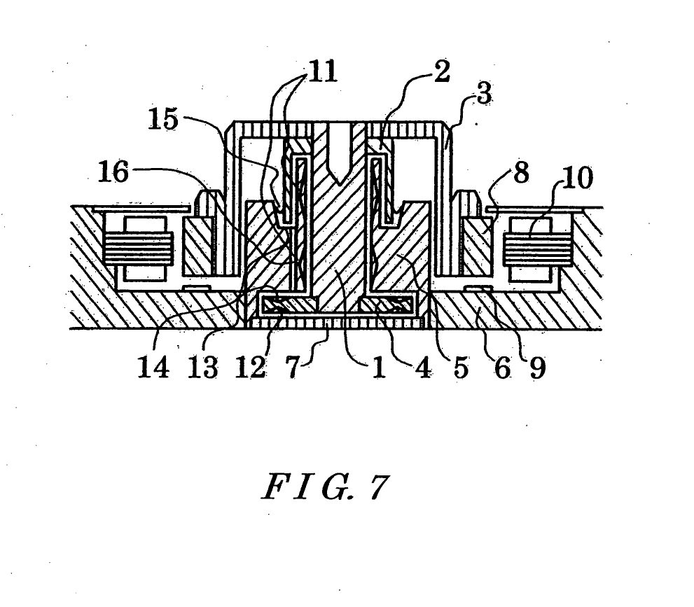

FIG. 7 is a cross-sectional diagram of a spindle motor including a hydrodynamic bearing device according to the fourth embodiment of the present invention. In the above hydrodynamic bearing devices of the second and third embodiments, the communication hole 16 is formed from the outer peripheral side of the thrust bearing. The hydrodynamic bearing device of the present embodiment is different in that the communication hole 16 is formed from the inner peripheral side of the thrust bearing.

In the present embodiment, when the thrust sub-hydrodynamic grooves 13 have a herringbone pattern, for example, a negative pressure tends to generate at a gap between the radial hydrodynamic grooves 11 and the thrust sub-hydrodynamic grooves 13. Thus, the communication hole 16 is connected to the bottom surface of the upper recessed portion 14.

With such a structure, the diameter of the seal portion 15 can be reduced. Accordingly, the peripheral speed at the seal portion 15 becomes slower and rippling of the lubricating oil due to surface roughness of the seal portion 15 or the like is reduced. Thus, the sealing performance can be further improved. Moreover, since the communication hole 16 can be formed along the vertical direction, the cost for machining can be reduced.

According to the structure of the present embodiment, effects achieved by the structure described in the first embodiment and the like can also be achieved.

### Fifth Embodiment

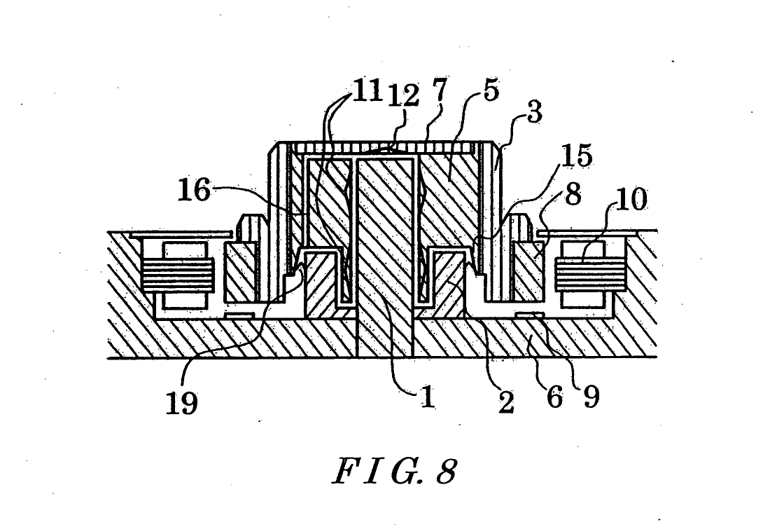

FIG. 8 is a cross-sectional view of a spindle motor including a hydrodynamic bearing device according to the fifth embodiment of the present invention. The above hydrodynamic bearing device of the first embodiment is of a shaft rotational type in which the shaft 1 rotates. The hydrodynamic bearing device of the present embodiment is different in that it is of a shaft fixed type, in which a sleeve 5 rotates with respect to a flangeless shaft 1 which is fixed.

In the hydrodynamic bearing device of the present embodiment, a thrust plate 7 is attached so as to cover the upper surface of the shaft 1 and/or the sleeve 5. On a thrust plate 7, thrust hydrodynamic grooves 12 are formed, and the thrust bearing is formed between a lower surface (as shown in the figure) of the thrust plate 7 and the shaft 1. A cover plate 2 having a substantially annular shape (cup shape) is attached to an outer peripheral surface of the shaft 1. A part of the cover plate 2 is inserted into a lower recessed portion 19, which is formed on a lower surface of the sleeve 5 with a gap interposed therebetween.

With such a structure, the radial bearing portion and the seal portion 15 do not overlap each other in the axial direction. Thus, a sufficient length of the radial bearing can be secured. Since the seal portion 15 is sufficiently remote from the radial bearing and the thrust bearing, the influence of the bearing portions on the seal portion 15 can be reduced. Therefore, even when the hydrodynamic pressures generated at the bearing portions have an imbalanced distribution, the sealing performance does not deteriorate. Furthermore, since the thrust bearing is provided between the shaft 1 and the thrust plate 7, even if the hub 3 deforms when a disc or the like is attached to the hub 3, the thrust bearing performance can be prevented from deteriorating. Such effects similar to those described above can be achieved.

Moreover, since the hub 3 is attached to the outer periphery of the sleeve 5, an area of attached portion of the hub 3 can be increased. Thus, a fastening force of the hub can be further improved.

In FIG. 8, a stopper structure for the rotor portion (rotary member), which is formed of the sleeve 5, the hub 3, the magnet 8, and the thrust plate 7, is not shown. However, a stopper structure may be formed by providing an locking structure between the rotary member such as a rotor portion and a stationary portion (fixed member), which is formed of the base 6, the shaft 1, and the cover plate 2.

According to the structure of the present embodiment, effects achieved by the structure described in the first embodiment and the like can also be achieved.

### Sixth Embodiment

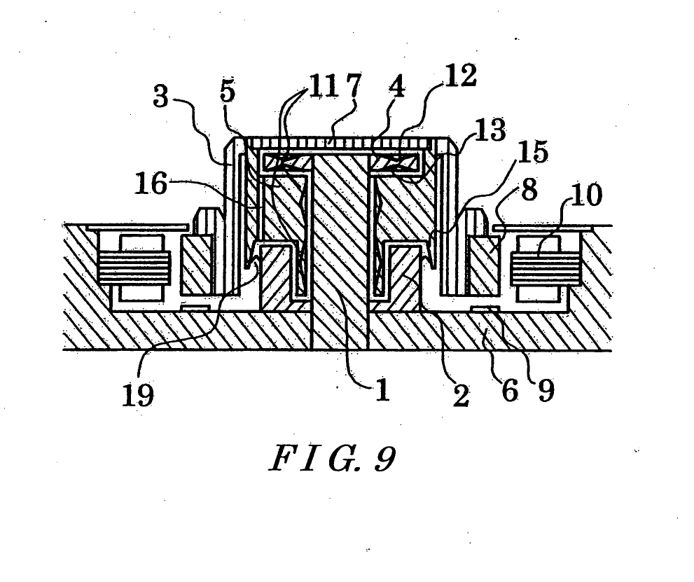

FIG. 9 is a cross-sectional view of a spindle motor including a hydrodynamic bearing device according to the sixth embodiment of the present invention. The above hydrodynamic bearing devices of the second through fourth embodiments are of a shaft rotational type in which the shaft 1 rotates. The hydrodynamic bearing device of the present embodiment is different in that it is of a shaft fixed type, in which a sleeve 5 rotates with respect to a shaft 1 which is fixed. The shaft 1 and a cover plate 2 may be integral.

In the hydrodynamic bearing device of the present embodiment, a thrust plate 7 is attached so as to cover the upper surface of the shaft 1 and/or the sleeve 5. A cover plate 2 having a substantially annular shape (cup shape) is attached to an outer peripheral surface of the shaft 1. A part of the cover plate 2 is inserted into a lower recessed portion 19, which is formed on a lower surface of the sleeve 5, with a predetermined gap interposed therebetween. To the shaft 1, a thrust flange 4 is integrally fixed or formed. On an upper surface (as shown in the figure) of the thrust flange 4, thrust hydrodynamic grooves 12 are formed so as to form the thrust bearing with the lower surface (as shown in the figure) of the thrust plate 7. On a lower surface (as shown in the figure) of the thrust flange 4, thrust sub-hydrodynamic grooves 13 are formed so as to form the thrust sub-bearing with an end surface of the sleeve 5. The thrust sub-bearing does not have to be always provided.

With such a structure, the radial bearing portion and the seal portion 15 do not overlap each other in the axial direction. Thus, a sufficient length of the radial bearing can be secured. Since the seal portion 15 is sufficiently remote from the radial bearing and the thrust bearing, the influence of the bearing portions on the seal portion 15 can be suppressed to the minimum. Even when balance of the hydrodynamic pressures generated at the bearing portions is disturbed, the sealing performance can be prevented from deteriorating. Furthermore, since the thrust bearings are provided between the thrust flange 4 and the thrust plate 7, and between the thrust flange 4 and the sleeve 5, even if the hub 3 deforms when a disc or the like is attached to the hub 3, the thrust bearing performance can be prevented from deteriorating. Such effects similar to those described above can be achieved.

Moreover, when such a structure is employed, since the hub 3 is attached to the outer periphery of the sleeve 5, an area of attached portion can be increased. Thus, a fastening force of the hub can be further improved.

### Seventh Embodiment

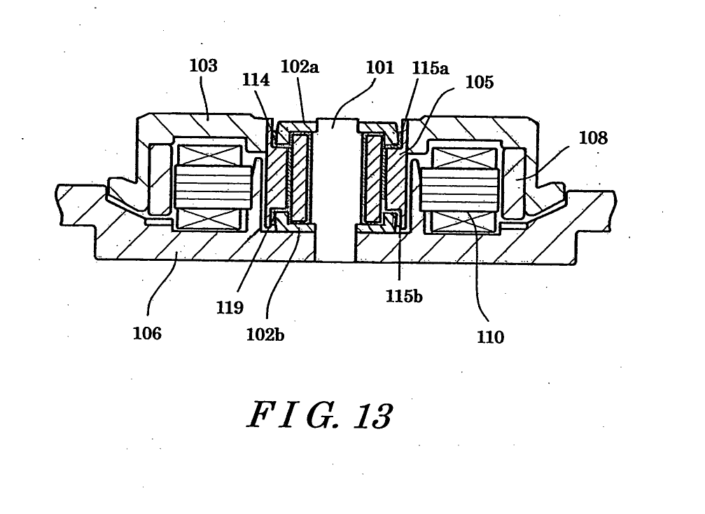

FIG. 13 is a cross-sectional diagram of the spindle motor including a hydrodynamic bearing device according to the seventh embodiment of the present invention. In the above hydrodynamic bearing devices of the first through sixth embodiments, the upper recessed portion 14 or the lower recessed portion 19 is provided on one of the upper surface and the lower surface of the sleeve 5 so as to insert the cover plate 2 thereinto. The present embodiment is different in that it is of a tide type, in which a recessed portions 114 and 119 are formed on both upper and lower surfaces of a sleeve 105, and cover plates 102a and 102b are inserted into the recessed portions.

The spindle motor including the hydrodynamic bearing device of the present embodiment includes a shaft 101, the cover plates 102a and 102b, a hub 103, the sleeve 105, a base 106, a magnet 108, and a stator core 110. The cover plates 102a and 102b are attached near upper and lower end portions of the outer peripheral surface of the shaft 101, respectively. The cover plates 102a and 102b are partially inserted into the upper recessed portion 114 and the lower recessed portion 119 formed on upper and lower end surfaces of the sleeve 105, respectively, with a predetermined gap interposed therebetween.

With such a structure, a capillary seal portion 115a can be formed between an outer peripheral surface of the upper cover plate 102a and an inner peripheral surface of the upper recessed portion 114, and a capillary seal portion 115b can be formed between an outer peripheral surface of the lower cover plate 102b and an inner peripheral surface of the lower recessed portion 119. Since the capillary seal portions 115a and 115b can be located remote from the bearing portions, the radial bearing portion does not overlap the capillary seal portions 115a and 115b in the axial direction. Thus, a sufficient length of the radial bearing can be secured. The capillary seal portions 115a and 115b are sufficiently remote from the radial bearing and the thrust bearing with buffer portions 120 being interposed therebetween. The buffer portions 120 are formed between portions of upper and lower end surfaces of the cover plates 102a and 102b inserted into the upper and lower recessed portions 114 and 119, respectively, and bottom surfaces of the upper and lower recessed portions 114 and 119, which oppose thereto, and between portions of the inner peripheral surfaces of the cover plates 102a and 102b and surfaces of the sleeve 105, which oppose thereto. Thus, the influence of the bearing portions on the capillary seal portions 115a and 115b can be reduced. Therefore, even when the hydrodynamic pressures generated at the bearing portions have an imbalanced distribution, the sealing performance does not deteriorate. Furthermore, since the hub 103 is attached to the sleeve 105, even if the hub 103 deforms when a disc or the like is attached to the hub 103, the thrust bearing performance can be prevented from deteriorating. Such effects similar to those described above can be achieved.

Moreover, the above-mentioned buffer portions 120 can be formed so as to have a sufficient length in the axial direction without increasing the length of the bearing. Thus, influence due to a change in hydrodynamic pressure distribution balance at the bearing portions can be avoided.

### Other Embodiments

In the first through sixth embodiments, the spindle motor is of an inner-rotor type. However, the above embodiments can be applied to motors of an outer-rotor type and the like.

Further, the bearing device of the present embodiment and the hydrodynamic bearing device using the same can be used as a rotary drive device of HDDs, polygon mirrors, optical disc apparatuses, and the like.

### INDUSTRIAL APPLICABILITY

The present invention can be applied to spindle motors particularly suitable as spindle motors of hard disc device, or other devices. However, the present invention can be applied to other types of apparatuses.

1. A hydrodynamic bearing device, comprising:
a shaft member configured to serve as a center of rotation of a rotary member with respect to a fixed member and have a shaft of a substantially columnar shape and a cover plate of a substantially annular shape:
a sleeve configured to relatively rotate with respect to the shaft member and have a recessed portion formed on a surface crossing an axial direction so as to accommodate a part of the cover plate with a gap interposed therebetween on both an inner peripheral side and an outer peripheral side;
a capillary seal portion configured to hold a lubricant in a gap between an inner peripheral surface of the recessed portion of the sleeve and an outer peripheral surface of the cover plate;
a bearing portion configured to be formed in a gap between the fixed member and the rotary member; and
a buffer portion configured to be formed in the gap between the cover plate and the recessed portion and secure a distance between the capillary seal portion and the bearing portion.

2. A hydrodynamic bearing device according to claim 1, wherein:
the rotary member includes the shaft member.

3. A hydrodynamic bearing device according to claim 1, wherein:
the rotary member includes the sleeve.

4. A hydrodynamic bearing device according to claim 1, wherein:
the shaft member includes a thrust flange integral to the shaft.

5. A hydrodynamic bearing device according to claim 2, further comprising:
a thrust plate configured to be attached to a covered end of the sleeve and be placed so as to oppose an end surface of the shaft in the axial direction.

6. A hydrodynamic bearing device according to claim 3, further comprising:
a thrust plate configured to be attached to a covered end of the sleeve and be placed so as to oppose an end surface of the shaft in the axial direction.

7. A hydrodynamic bearing device according to claim 1, wherein:
the cover plate, the recessed portion, and the capillary seal portion are provided on both ends in the axial direction.

8. A hydrodynamic bearing device according to claim 1, wherein:
the sleeve further includes a communication hole which interconnects one end surface in the axial direction to a bottom surface of the recessed portion; and
the capillary seal portion and an opening of the communication hole are located at positions having different distances from the center of rotation.

9. A hydrodynamic bearing device according to claim 7, wherein:
the sleeve further includes a communication hole which connects bottom surfaces of the recessed portions provided on both ends in the axial direction; and
the capillary seal portion and an opening of the communication hole are located at positions having different distances from the center of rotation.

10. A hydrodynamic bearing device including a stationary member and a rotary member, which has a lubricant in a gap with the stationary member and can relatively rotate with respect to the stationary member, wherein:
the rotary member includes a shaft member and a hub attached to the shaft member;
the shaft member is formed to include a shaft and a cover plate;
the stationary member includes a base and a sleeve attached to the base;
the sleeve has an inner peripheral surface which opposes an outer peripheral surface of the shaft in a radial direction;
the sleeve has a thrust plate configured to cover one end of the inner peripheral surface attached thereto;
a surface of the thrust plate on one end in an axial direction is located so as to oppose a surface of the shaft on the other end in the axial direction;
a recessed portion configured to accommodate a part of the cover plate is formed on a surface of the sleeve on the one end in the axial direction;
a seal portion configured to hold the lubricant is formed between an inner peripheral surface of the recessed portion of the sleeve and an outer peripheral surface of the cover plate; and
a hydrodynamic groove is not formed on the recessed portion of the sleeve and a surface of the cover plate, which opposes the recessed portion.

11. A hydrodynamic bearing device according to claim 10, further comprising:
a radial bearing portion formed of the lubricant interposed into a gap between the outer peripheral surface of the shaft and the inner peripheral surface of the sleeve, and hydrodynamic grooves formed on at least one of the outer peripheral surface of the shaft and the inner peripheral surface of the sleeve; and
a thrust bearing portion formed of the lubricant filled into a gap between the surface of the shaft on the other end in the axial direction and the surface of the thrust plate on the one end in the axial direction, and hydrodynamic grooves formed on at least one of the surface of the shaft on the other end in the axial direction and the surface of the thrust plate on the one end in the axial direction.

12. A hydrodynamic bearing device according to claim 10, wherein:
a communication hole configured to connect the thrust bearing portion of the sleeve and the recessed portion of the sleeve is formed.

13. A hydrodynamic bearing device including a stationary member and a rotary member, which has a lubricant in a gap with the stationary member and can relatively rotate with respect to the stationary member, wherein:
the rotary member includes a shaft member and a hub attached to the shaft member;
the shaft member includes a shaft, a cover plate, and a thrust flange;
the stationary member includes a base and a sleeve attached to the base;
the sleeve has an inner peripheral surface which opposes an outer peripheral surface of the shaft in a radial direction;
the sleeve has a thrust plate configured to cover one end of the inner peripheral surface attached thereto;
a surface of the thrust flange on one end and a surface of the thrust flange on the other end in an axial direction are located so as to oppose a surface of the sleeve on the other end in the axial direction and a surface of the thrust plate on the one end in the axial direction, respectively;
a recessed portion configured to accommodate a part of the cover plate is formed on a surface of the sleeve on the one end in the axial direction;
a seal portion configured to hold the lubricant is formed between an inner peripheral surface of the recessed portion of the sleeve and an outer peripheral surface of the cover plate; and
a hydrodynamic groove is not formed on the recessed portion of the sleeve and a surface of the cover plate on the other end in the axial direction, which opposes the recessed portion.

14. A hydrodynamic bearing device according to claim 12, further comprising:
a radial bearing portion formed of the lubricant interposed into a gap between the outer peripheral surface of the shaft and the inner peripheral surface of the sleeve, and hydrodynamic grooves formed on at least one of the outer peripheral surface of the shaft and the inner peripheral surface of the sleeve; and
a thrust bearing portion formed of the lubricant filled into a gap between the surface of the thrust flange on the other end in the axial direction and the surface of the thrust plate on the one end in the axial direction, and hydrodynamic grooves formed on at least one of the surface of the thrust flange on the other end in the axial direction and the surface of the thrust plate on the one end in the axial direction.

15. A hydrodynamic bearing device according to claim 13, further comprising:
a communication hole configured to connect the other end of the sleeve in the axial direction and the recessed portion of the sleeve formed on one end in the axial direction.

16. A hydrodynamic bearing device according to claim 15, further comprising:
a second thrust bearing portion formed of the lubricant filled into a gap between the surface of the sleeve on the other end in the axial direction and the surface of the thrust flange on the one end in the axial direction, and hydrodynamic grooves formed on at least one of the surface of the sleeve on the other end in the axial direction and the surface of the thrust flange on the one end in the axial direction.

17. A hydrodynamic bearing device according to claim 10, wherein
the radial bearing portion are provided with radial hydrodynamic grooves of a pumping-in shape configured to press the lubricant in the axial direction from an opening side to the covered side of the bearing member.

18. A hydrodynamic bearing device according to claim 10, wherein
the seal portion has a shape including at least one tapered portion, such that a space between the inner peripheral surface of the recessed portion of the sleeve on the one end in the axial direction and the outer peripheral surface of the cover plate gradually expands from a bottom surface of the recessed portion of the sleeve on the one end in the axial direction, on at least one of the inner peripheral surface of the recessed portion of the sleeve on the one end in the axial direction and the outer peripheral surface of the cover plate.

19. A hydrodynamic bearing device according to claim 10, wherein
the seal portion has a shape including at least one stepped portion, such that a space between the inner peripheral surface of the recessed portion of the sleeve and the outer peripheral surface of the cover plate gradually expands from a bottom surface of the recessed portion of the sleeve, on at least one of the inner peripheral surface of the recessed portion of the sleeve and the outer peripheral surface of the cover plate.

20. A hydrodynamic bearing device including a stationary member and a rotary member, which has a lubricant in a gap with the stationary member and can relatively rotate with respect to the stationary member, wherein:
the stationary member includes a base and a shaft member attached to the base;
the shaft member includes a shaft and a cover plate;
the rotary member includes a sleeve and a hub attached to the sleeve;
the sleeve has an inner peripheral surface which opposes an outer peripheral surface of the shaft in a radial direction;
the sleeve has a thrust plate configured to cover one end of the inner peripheral surface attached thereto;
a surface of the thrust plate on the other end in an axial direction opposes a surface of the shaft on one end in the axial direction;
a recessed portion configured to accommodate a part of the cover plate is formed on a surface of the sleeve on the other end in the axial direction, and a seal portion configured to hold the lubricant is formed between an inner peripheral surface of the recessed portion of the sleeve and an outer peripheral surface of the cover plate; and
a hydrodynamic groove is not formed on the recessed portion of the sleeve and a surface of the cover plate, which opposes the recessed portion.

21. A hydrodynamic bearing device including a stationary member and a rotary member, which has a lubricant in a gap with the stationary member and can relatively rotate with respect to the stationary member, wherein:
the stationary member includes a base and a shaft member attached to the base;
the shaft member includes a shaft and a cover plate;
the rotary member includes a sleeve and a hub attached to the sleeve;
the sleeve has an inner peripheral surface which opposes an outer peripheral surface of the shaft in a radial direction;
the sleeve has a thrust plate configured to cover one end of the inner peripheral surface attached thereto;
a surface of the thrust plate on the other end in an axial direction opposes a surface of the thrust flange on one end in the axial direction;
a surface of the sleeve on the one end in an axial direction opposes a surface of the thrust flange on the other end in the axial direction;
a recessed portion configured to accommodate a part of the cover plate is formed on a surface of the sleeve on the other end in the axial direction, and a seal portion configured to hold the lubricant is formed between an inner peripheral surface of the recessed portion of the sleeve and an outer peripheral surface of the cover plate; and
a hydrodynamic groove is not formed on the recessed portion of the sleeve and a surface of the cover plate, which opposes the recessed portion.

22. A motor comprising a hydrodynamic bearing device according to claim 1.

23. A recording and reproducing apparatus comprising a motor according to claim 22.

24. A hydrodynamic bearing device according to claim 13, wherein
the radial bearing portion are provided with radial hydrodynamic grooves of a pumping-in shape configured to press the lubricant in the axial direction from an opening side to the covered side of the bearing member.

25. A hydrodynamic bearing device according to claim 13, wherein
the seal portion has a shape including at least one tapered portion, such that a space between the inner peripheral surface of the recessed portion of the sleeve on the one end in the axial direction and the outer peripheral surface of the cover plate gradually expands from a bottom surface of the recessed portion on of the sleeve the one end in the axial direction, on at least one of the inner peripheral surface of the recessed portion of the sleeve on the one end in the axial direction and the outer peripheral surface of the cover plate.

26. A hydrodynamic bearing device according to claim 13, wherein
the seal portion has a shape including at least one stepped portion, such that a space between the inner peripheral surface of the recessed portion of the sleeve and the outer peripheral surface of the cover plate gradually expands from a bottom surface of the recessed portion of the sleeve, on at least one of the inner peripheral surface of the recessed portion of the sleeve and the outer peripheral surface of the cover plate.
